(19) United States
(12) Patent Application Publication
(10) Pub. No.: US 2006/0042557 A1
(43) Pub. Date: Mar. 2, 2006

(54) Small intelligent hatcher

(75) Inventors: Xiping Liu, Guangdong (CN); Zhenhua Tao, Guangdong (CN)

Correspondence Address: BIRCH STEWART KOLASCH & BIRCH, PO BOX 747, FALLS CHURCH, VA, 22040-0747, US

(73) Assignee: Xiping Liu, Guangdong (CN)

(21) Appl. No.: 10/924,951

(22) Filed: Aug. 25, 2004

(51) Int. Cl. A01K 41/02

(52) U.S. Cl. 119/318

(57) ABSTRACT

A small intelligent hatcher comprising a shell body with a supporting shelf; an egg container, a rolling device, a heating device and a control circuitry are on the supporting shelf; the rolling device further consists of a transmission and a motor; the egg container is on the top of the output axis of the transmission, the back of the output axis of the transmission connects to a limitation indicator, two limitation switches each is on one end of the limitation indicator and connects to the control circuitry to control the rolling direction and angle of the motor; the heating device and the fan connect to the control circuitry to control the temperature; an observation window is on the front of the shell body is suitable for children to observe and record.

### BACKGROUND OF THE INVENTION

I. Field of the Invention

This invention relates generally to a small hatcher and, more specifically, to a small intelligent hatcher that keeps rolling the eggs placed onto the egg container, the surface of eggs can be heated evenly, the embryo will not stick on the egg shell while hatching.

II. Description of the Prior Art

Heretofore, it is known that nature science is very important in elementary education; nature phenomenon observation is conducted very often. The present invention has simple in structure, small in size, light weight benefits to roll egg inside the container, the egg is rolled automatically to be heated evenly, the embryo will not stick on the egg shell, the present invention is very suitable for children to experiment and record the observation.

### SUMMARY OF THE INVENTION

It is therefore a primary object of the invention to provide a small intelligent hatcher that keeps rolling the eggs placed onto the egg container, the surface of eggs can be heated evenly, the embryo will not stick on the egg shell while hatching; the front observation window is very suitable for children to experiment and record the observation.

In order to achieve the objective set forth, a small intelligent hatcher in accordance with the present invention comprises a shell body with a supporting shelf; an egg container, a rolling device, a heating device and a control circuitry are on the supporting shelf; the rolling device further consists of a transmission and a motor; the egg container is on the top of the output axis of the transmission, the back of the output axis of the transmission connects to a limitation indicator, two limitation switches each is on one end of the limitation indicator and connects to the control circuitry to control the rolling direction and angle of the motor; the heating device and the fan connect to the control circuitry to control the temperature; an observation window is on the front of the shell body.

While application based on the structure described above, eggs are placed onto the egg frames of the egg container through the observation window, the temperature of the heating device is control by the control circuitry, the output axis of the transmission of the rolling device connects to the egg stand of the egg container, the end of the output axis of the transmission of the rolling device connects to the limitation indicator, two limitation switches each is on one end of the limitation indicator; when the output axis of the transmission rolls, the limitation indicator turns along with the output axis, when the bottom of the limitation indicator touches the limitation switches, the limitation indicator sends out a signal to the control circuitry to have the motor of the rolling device turn reversely; such mechanism makes the egg frames on both ends of the egg stand move up and down similar to seesaw; to move up and down continuously, the surface of the eggs inside the egg container can be heated evenly, the embryo will not stick on the egg shell during hatch; the control circuitry controls the internal temperature; a transparent observation window on front is very suitable for children to experiment and record the observation.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is an assembly view of the present invention;

FIG. 2 is a perspective view of the present invention;

FIG. 3 is a cross-sectional view of a further embodiment of the present invention;

FIG. 4A is an application view of a further embodiment of the present invention;

FIG. 4B is another application view of a further embodiment of the present invention;

FIG. 5 is a cross-sectional view of another application of the present invention.

### DESCRIPTION OF THE PREFERRED EMBODIMENT

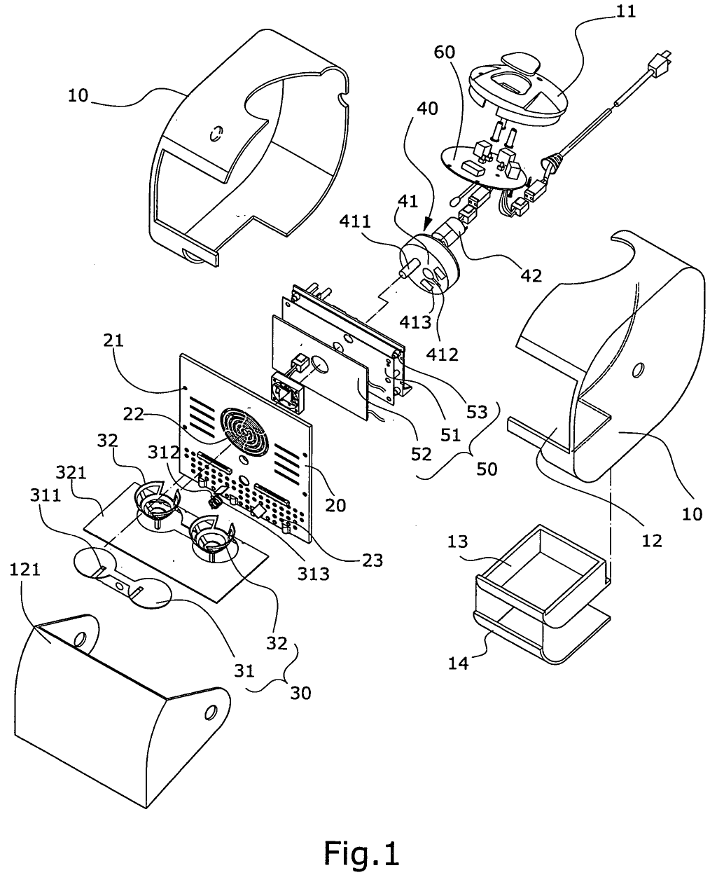

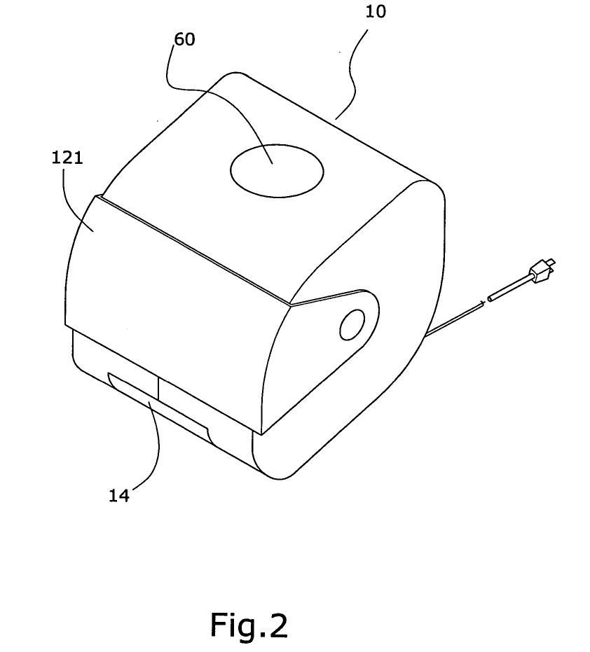

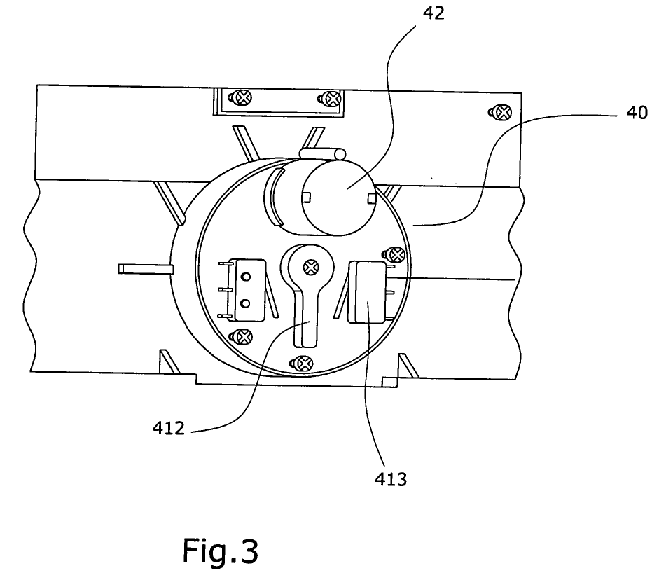

Referring to FIG. 1 to FIG. 3, the present invention comprises a shell body 10 with a supporting shelf 20; an egg container 30, a rolling device 40, a heating device 50 and a control circuitry 60 are on the supporting shelf 20. The function of each component is described as following:

The shell body 10 has a box 11 on top, the heating device 50 and the control circuitry 60 controlling the temperature are inside the box 11, an observation window 12 is in front of the shell body 10, a glass door 121 is in front of the observation window 12 for users to take the objects out or observe; a removable water container 13 is beneath the observation window 12 of the shell body 10, a removable article shelf 14 is beneath the water container 13, the water container 13 can contain the liquid flowing out from the cracked egg shell.

The supporting shelf 20 is made of metal and is in board shape, several fastening holes 21 to stable the heating device 50 and several ventilation holes 22 for hot air to pass are on top of the supporting shelf 20, several air holes 23 are beneath the supporting shelf 20.

The egg container 30 further consists of an egg stand 31 with two egg frames 32 on top; the cross section of the output axis 411 of the rolling device 40 is in semicircle shape, the corresponding semicircle hole 311 is on the egg stand 31 to install the egg stand 31 on the output axis 411, the corresponding axis does not roll and is fixed by a fastening stem 312, a spring 313 is installed on the output axis 411, the spring 313 is between the fastening stem 312 and the egg stand 31, a decorating board 321 is installed between the supporting shelf 20 and the egg frames 32.

The rolling device 40 has the transmission 41 install on the front of a motor 42, the transmission 41 is a gear type mechanism; the output axis 411 stretches out from the front the transmission 41, the egg container 30 is on the top of the output axis 411 of the transmission 41 of the rolling device 40, the back of the output axis 411 of the transmission 41 connects to a limitation indicator 412, two limitation switches 413 each is on one end of the limitation indicator 412 and connects to the control circuitry 60 to control the rolling direction and angle of the motor 42.

The heating device 50 consists of a heating board 51 with a heating paper 52 on front; the heating paper 52 and the heating board 51 pass through the installation board 53 and are fixed onto the supporting shelf 20.

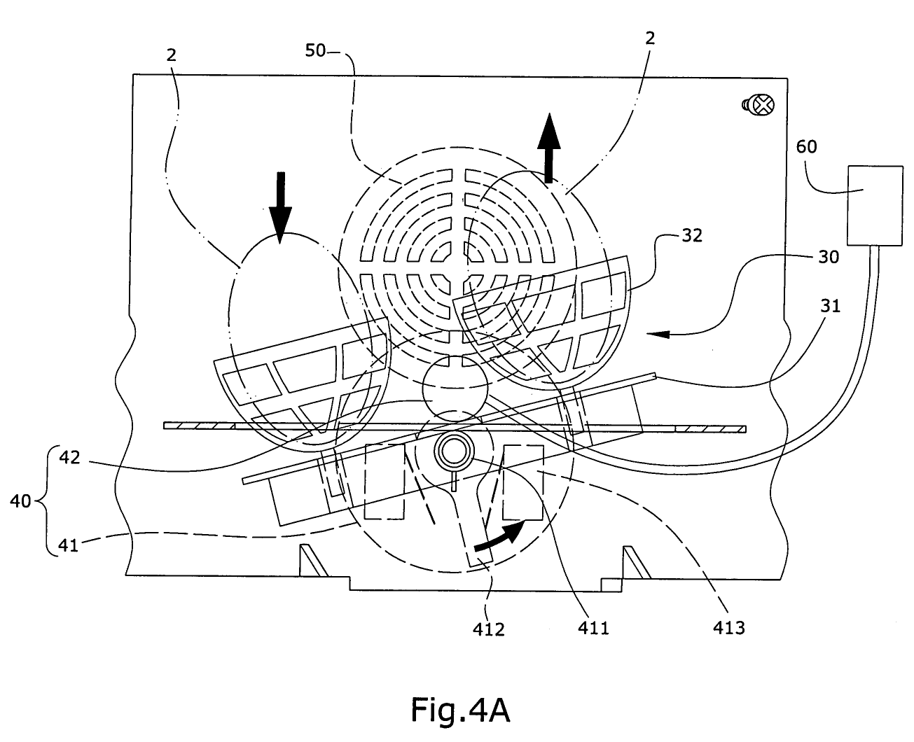

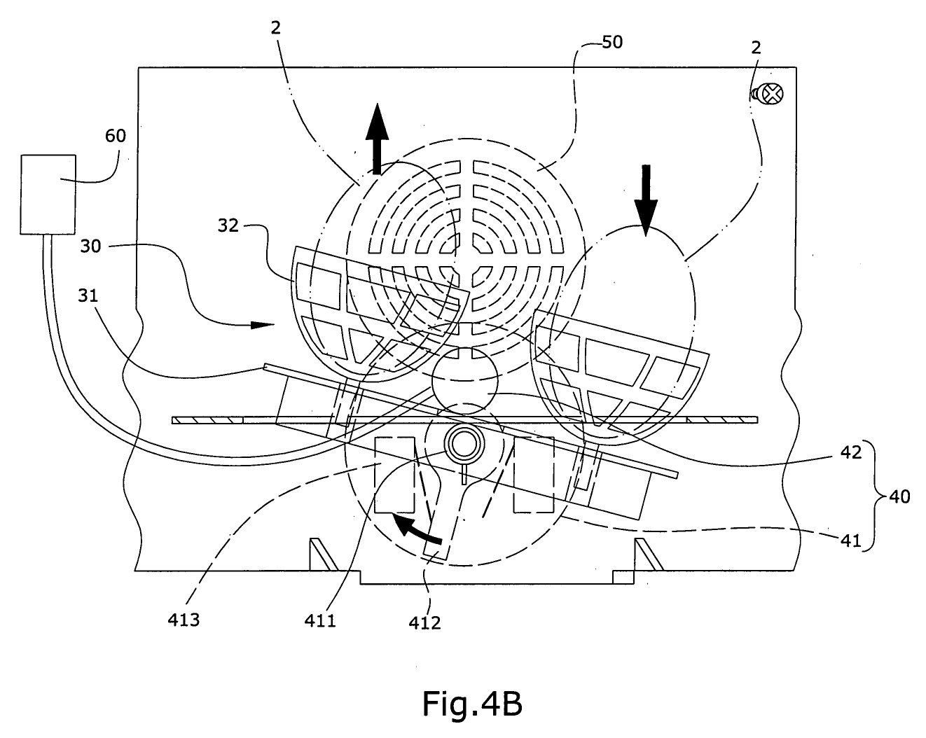

Referring to FIG. 4A and FIG. 4B, the application charts of the present invention, the eggs 2 are placed onto the egg frames 32 of the egg container 30, the control circuitry 60 controls the temperature of the heating device 50; the end of the output axis 411 of the transmission 41 of the rolling device 40 connects to the limitation indicator 412, two limitation switches 413 each is on one end of the limitation indicator 412; when the output axis 411 of the transmission 41 rolls, the limitation indicator 412 turns along with the output axis 411, when the bottom of the limitation indicator 412 touches the limitation switches 413, the limitation indicator 412 sends out a signal to the control circuitry 60 to have the motor 42 of the rolling device 40 turn reversely; such mechanism makes the egg frames 32 on both ends of the egg stand 31 move up and down similar to seesaw; to move up and down continuously, the surface of the eggs 2 inside the egg container 30 can be heated evenly, the embryo will not stick on the egg shell during hatch.

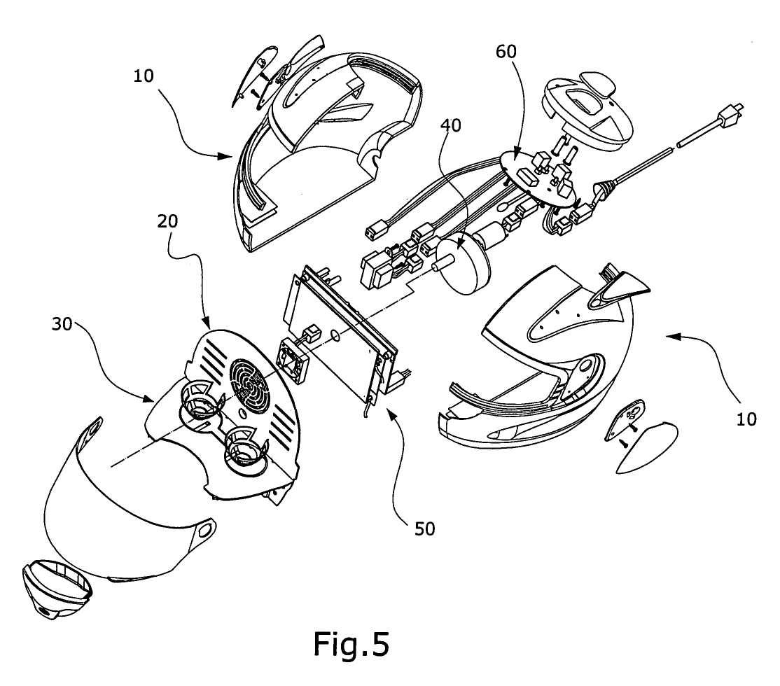

Referring to FIG. 5, another application example of the present invention, the shell body 10 is in cap shape, the supporting shelf 20 is installed on the center of he shell body 10, the egg container 30, the rolling device 40, the heating device 50 and the control circuitry 60 are inside the proper location inside the shell body 10.

While a preferred embodiment of the invention has been shown and described in detail, it will be readily understood and appreciated that numerous omissions changes and additions may be made without departing from the spirit and scope of the invention.

What is claimed is:

1. A small intelligent hatcher comprising:
a shell body 10 with a supporting shelf, an egg container, a rolling device, a heating device and a control circuitry are on said supporting shelf, said egg container is on top of said rolling device, a transmission is inside said rolling device, the back of an output axis of said transmission connects to a limitation indicator, two limitation switches each is on one end of said limitation indicator and connects to said control circuitry to control the rolling direction and angle of a motor, such mechanism makes said egg frames on both ends of the egg stand move up and down similar to seesaw, said heating device heats up the system, an observation window on front of said body shell for users to observe.

2. The small intelligent hatcher recited in claim 1, wherein a box on top of said shell body, said heating device connecting to said control circuitry is inside said box.

3. The small intelligent hatcher recited in claim 1, wherein said observation window is in front of said shell body, a glass door is in front of said observation window.

4. The small intelligent hatcher recited in claim 1, wherein a removable water container is beneath said observation window.

5. The small intelligent hatcher recited in claim 1, wherein a removable article shelf is beneath said water container.

6. The small intelligent hatcher recited in claim 1, wherein said supporting shelf is made of metal and is in board shape, several fastening holes to stable said heating device and several ventilation holes for hot air to pass are on top of said supporting shelf, several air holes are beneath said supporting shelf.

7. The small intelligent hatcher recited in claim 1, wherein said egg container further consists of an egg stand with two egg frames on top, the cross section of said output axis is in semicircle shape, a corresponding semicircle hole is on said egg stand to install said egg stand on said output axis, a fastening stem stable said egg stand.

8. The small intelligent hatcher recited in claim 1, wherein said rolling device has said transmission install on the front of said motor, said output axis stretches out from the front said transmission, said egg container is on the top of said output axis of said transmission, the back of said output axis of said transmission connects to a limitation indicator, two limitation switches each is on one end of said limitation indicator and connects to said control circuitry to control the rolling direction and angle of said motor.

9. The small intelligent hatcher recited in claim 1, wherein said heating device consists of a heating board with a heating paper on front, said heating paper and said heating board pass through a installation board and are fixed onto said supporting shelf.

10. The small intelligent hatcher recited in claim 1, wherein said transmission is a gear type mechanism.

11. The small intelligent hatcher recited in claim 1, wherein a spring is installed on said output axis, said spring is between said fastening stem and said egg stand.
